(19) United States
(12) Patent Application Publication
(10) Pub. No.: US 2005/0028213 A1
(43) Pub. Date: Feb. 3, 2005

(54) System and method for user-friendly fast forward and backward preview of video

(75) Inventors: Yoram Adler, Haifa (IL); Gal Ashour, Yokneam Ilit (IL); Konstantin Kupeev, Haifa (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/632,045

(22) Filed: Jul. 31, 2003

(51) Int. Cl. H04N 7/173

(52) U.S. Cl. 725/89; 725/105; 725/90

(57) ABSTRACT

A method and apparatus for producing fast forward and backward preview in an incoming sequence of video frames automatically select the representative frames from the video in accordance with the video content Respective representative frames F_{R} are displayed for a longer time period than that dictated by the display speed. The representative frames are selected sufficiently rarely to facilitate the user's perception and to reduce the effect of fatigue. On the other hand, the selected frames adequately represent the initial video content. In a preferred embodiment, the method does not demand the preprocessing of the video, possesses a small buffer memory, and allows selection of the representative frames in streaming fashion. This reduces the blinking that commonly occurs with hitherto-proposed approaches.

### FIELD OF THE INVENTION

This invention relates to video control for TV set-top-boxes.

### BACKGROUND OF THE INVENTION

Set-top-boxes (STBs) are ubiquitously used for TV broadcasting (both cable and satellite). Enhanced STBs include a built-in hard disk (HDD) and provide the user with enhanced multimedia experience and browsing modes. Some of these browsing modes are also referred to as ‘trick-modes’ and allow the user to watch the video sequence at various acceleration rates (e.g. fast forward, fast backward, etc.)

Usually, the service provider predefines the supported sub-set of acceleration rates, but in principle these acceleration rates are likely to be anything in the range 1×-30× for fast forward playback and (−1×)-(−30×) for fast backward playback. A drawback with known approaches is that the algorithms used for the trick-mode implementation are generally independent of the video content. Yet, different videos have different characteristics (rate of ‘changes’ on the screen in normal play mode is different in a golf game vs. a commercial or an action movie vs. an orchestra concert). Thus, a trick-mode implementation of fast forward/backward that is completely transparent to the video content is sub-optimal and the user experience may be degraded.

Attempts have been made in the art to address these shortcomings and provide video speed control that is sensitive to some extent to the video content.

Thus, US20020039481A1 (Jun et al.) published Apr. 4, 2002 and entitled “Intelligent video system” discloses a context-sensitive fast-forward video system that automatically controls a relative play speed of the video based on a complexity of the content, thereby enabling fast-forward viewing for summarizing an entire story or moving fast to a major concerning part. The complexity of the content is derived using information of motion vector, shot, face, text, and audio for an entire video and adaptively controls the play speed for each of the intervals on a fast-forward viewing of the corresponding video on the basis of the obtained complexity of the content. As a result, a complicated story interval is played relatively slowly and a simple and tedious part relatively fast, thereby providing a user with a summarized story of the video without viewing the entire video.

In such a system, the required information of motion vector, shot, face, text, and audio for the entire video is determined in advance and therefore such an approach is not amenable for use with streaming video and requires a large memory since the full content of video data must be stored for pre-processing. Moreover, the display speed varies depending on video content. This requires that for each section currently being displayed, there be associated a complexity factor. One way of doing this is explained in col. 4, lines 1ff where in a given frame interval there are defined an initial and end interval frame numbers, and a content complexity. These parameters are used to determine how fast or slow to display the frames defined by the frame interval. Specifically, frame intervals where the subject matter varies are displayed more slowly, while frame intervals where the subject matter is nearly constant are displayed more quickly. But in all cases all frames in the defined frame interval are displayed. Moreover, in the case that the content varies significantly in the frame interval, the frames may be displayed too quickly: resulting in blinking of the images, which is unpleasant.

An alternative approach is described in paragraph [0064] on page 4. The complexity of each frame is computed and an average complexity of a group of frames is then calculated. If the average complexities of adjacent groups are similar, then the groups are concentrated. For each group, there is then computed an appropriate play speed in inverse-proportion to the complexity. In fact what is termed the “play speed” is really a sampling ratio: thus, for video segments of high complexity all frames are sampled, while as the complexity decreases fewer frames are sampled. On this basis, frame numbers are determined in each group for actual display: the faster the play speed, the fewer the number of frames selected. It is therefore to be noted that in this case, corresponding to a scene of low complexity, not all frames are displayed, but rather a smaller number of frames in each group is displayed. By way of example, consider a low-complexity video scene depicting a man walking slowly. As explained above, frames are skipped and, for example, frames 0, 10, 20, 30 . . . are displayed. This means that on fast forward the slowly walking man will appear to be running. In other words, at fast forward the slowly walking man and the fast running man will appear identical. This can also cause blinking owing to discontinuities in the content of the sampled frames.

When the scene is complex, all frames are sampled and displayed. Consider, for example, a complex scene depicting a man running. Since play speed is inversely proportional to the complexity, the “play” speed will be low. In the case that the play speed is at the lowest extreme i.e. equal to 1 (in his example) every single frame is displayed for a shorter period of time than would be done at normal play speed so as to achieve the required acceleration. This can also give rise to blinking owing to the eye's difficulty in accommodating sudden changes in content very quickly.

In all cases index information must be compiled and stored and in the case, that only selected frames are sampled the index information includes the frame number to be displayed.

The requirement to compile and store index information militates against use of such an approach for streaming video where data must be processed on-the-fly, since all the video data must be buffered in order to perform the preliminary computations of the average complexities and to allow concatenation, or re-grouping, of those frames intervals whose content has similar average complexities. Once this is done, the index information must be stored so that when the video is subsequently displayed, it will be known for how long to display each frame and, in accordance with one embodiment, which frames to display.

It also appears from the foregoing that when play speed is dependent on complexity, an actual speed increase can never be exactly quantified or predicted since the actual play speed of a segment depends on the complexity of the segment. In practice it is preferable that if a video takes 90 minutes to run at normal speed and it is played at ×10 speed increase, then it should take only 9 minutes to run at fast speed. But this may not be the case in Jun et al. since a proliferation of complex scenes tends to slow down the display and requires special correction as described in paragraph [0077].

Also of interest is U.S. Pat. No. 6,424,789 (Abdel-Mottaleb) assigned to Koninklijke Philips Electronics N.V., issued Jul. 23, 2002 and entitled “System and method for performing fast forward and slow motion speed changes in a video stream based on video content.” This patent discloses a video-processing device for use in a video editing system capable of receiving a first video clip containing at least one shot (or scene) consisting of a sequence of uninterrupted related frames and performing fast forward or slow motion special effects that vary according to the activity level in the shot. The video processing device comprises an image processor capable of identifying the shot and determining a first activity level within at least a portion of the shot. The image processor then performs the selected speed change special effect by adding or deleting frames in the first portion in response to the activity level determination, thereby producing a modified shot.

### SUMMARY OF THE INVENTION

It is an object of the invention to provide an improved method and system for producing fast forward and backward preview in a video sequence of frames that is amenable to video streaming and does not require varying content-sensitive display speeds.

It is a particular object to provide such a method that is amenable for use with on-the-fly video streaming, avoids blinking and employs minimal buffering, thereby saving computer resources over hitherto-proposed approaches.

To this end, there is provided in accordance with a broad aspect of the invention a method for producing fast forward and backward preview of video, the method comprising:
processing incoming frames so as to derive successive representative frames whose content is representative of successive video segments, and
displaying said successive representative frames at a rate that achieves a desired acceleration factor.

Such a method automatically selects the representative frames from a given video in accordance with the video content and the human visual system, thus enabling user friendly fast preview of the video (for both fast-forward and fast-backward trick-modes). Specifically, the representative frames are selected sufficiently rarely to facilitate the user's perception and to reduce the effect of fatigue. On the other hand the selected frames adequately represent the original video content.

Moreover, such a method does not require the pre-processing of the complete video, requires only a small buffer memory and allows the selection of the representative frames in a streaming fashion. The system displays the selected frames in a uniform manner and optionally supplies the user with additional information regarding the processed video (e.g. the current representative frame selection rate).

Optionally, the system performs the scene (shot) cut detection and selects one or more representative frames within the current shot using the shot information. “Shot” is a continuous sequence of frames captured by a camera. By “shot information” is meant any characteristics of the whole shot which could assist selection of the R-frames within a shot.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a block diagram showing functionally a TV system including a TV set-top box according to the invention;

FIG. 2 is a block diagram showing functionally details of the set-top box shown in FIG. 1;

FIG. 3 is a pictorial representation of a video stream comprising a sequence of frames arriving at the set-top box shown in FIG. 1;

FIG. 4 is a block diagram of an apparatus according to the invention for selecting R-Frames for display in a video streaming or buffered video system; and

FIG. 5 is a flow diagram showing one possible implementation of the segment processor shown in FIG. 4.

### DETAILED DESCRIPTION OF THE INVENTION

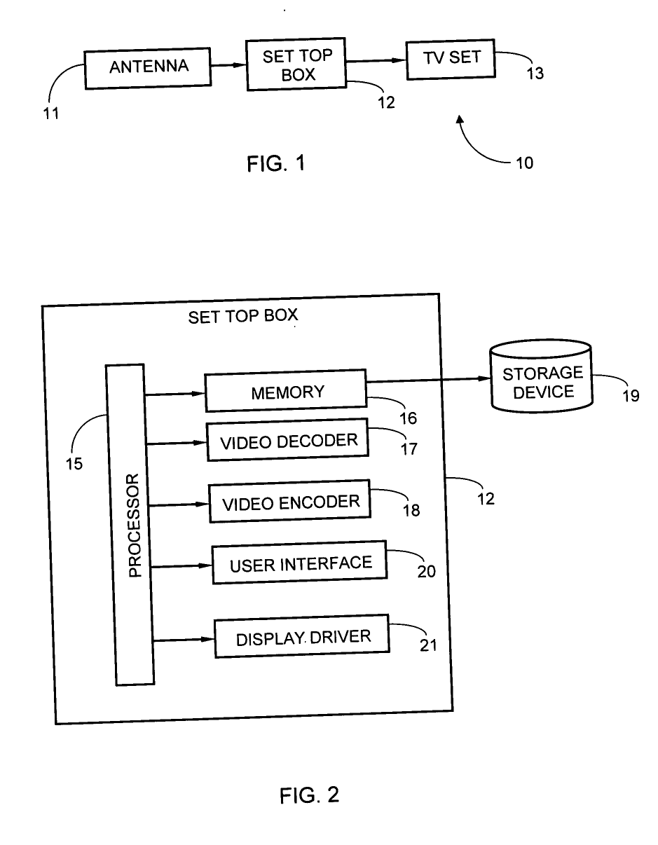

FIG. 1 shows functionally a system 10 comprising an antenna 11 that receives a TV signal and directs it via a set-top box 12 to a TV-display 13.

As shown in FIG. 2, the set-top box 12 includes a processor 15 coupled to a memory 16, a video decoder 17 and optionally a video encoder 18. Coupled to the memory 16 is a storage device 19, such as a hard-disk, recordable DVD etc. to which programs (videos) can be recorded for subsequent playing. Although in the figure, the storage device is external to the set-top box 12 it may also be inside the set-top box 12. The memory 16 stores instructions that are used by the processor in response to user commands fed thereto by a user interface 20 to provide multiple browsing modes including trick modes for simulating either fast forward or fast backward. The input stream fed by the antenna 11 is a full transport stream typically conforming to the MPEG-2 standard. During a recording, a partial stream is saved to the hard-disk 19. While in trick-mode, usually the audio is muted while the accelerated video is displayed. The following description will therefore concentrate on the video component and the manner in which a reduced number of frames are selected for display. For the sake of completeness, it is to be noted that a display driver 21 is coupled to the processor 15 for receiving frames for display. The display driver 21 may be external to the set-top box 12, in which case the set-top box 12 conveys successive frames to the display driver 21 for display.

In a preferred embodiment, a raw (usually encrypted) transport stream is received as input, and passes through a decryption phase after which the video decoder 17 reconstructs the audio and video data or a subset thereof, sequentially. An R-Frames selection algorithm is applied to the produced frames in order to select the best frames to be actually displayed at a selected acceleration rate.

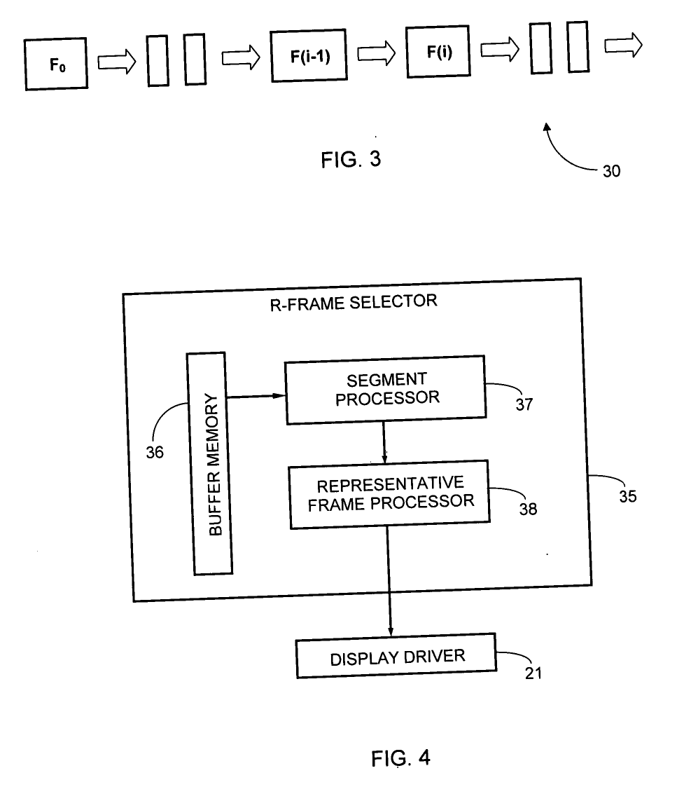

FIG. 3 is a pictorial representation of a video stream depicted generally as 30 comprising a sequence of frames arriving at the set-top box shown in FIG. 1. The video stream 30 comprises an initial frame F₀, and N frames preceding the current frame, including the current frame, denoted F(i), F(i−1), . . . , F(i−N+1). It is, however, to be noted that the N frames need not be sequential. For example, if the video content for the first five minutes of the video consists of identical frames, and the currently processed frame is the last frame of this time interval, then the most of the N frames have typically been selected from the beginning of the video. In such case, the segment containing preceding video frames will be much larger than N since the segment would contain the very large number of frames that have accrued since the beginning of the video, while N could be equal to 5, for example.

According to the general framework of the invention, for each current frame F(i) the decision module optionally determines whether there exists among the above N frames a frame FR which adequately represents the content of a video segment (further referred to as SEG) surrounding the current frame F(i) for the fast forward and backward operation. If the module selects the frame FR, it is displayed as the representative frame. Then the module receives the next frame F(i+1) which becomes a new current frame. If the module does not select the frame FR, it proceeds to the next frame F(i+1) which becomes a new current frame and the current representative frame (selected in an earlier iteration or during initialization) continues to be displayed.

It is important to note that the general framework allows various embodiments where selection of the frame FR and selection of the video segment SEG proceed in various ways. For example, in the first preferred embodiment of the invention (which works according to the blob detection algorithm [4, 5]), for each current frame F(i), the algorithm proceeds in one of two modes (further referred to as the “first mode” and “second mode”) briefly described below.

Initially, the algorithm is in the first mode. For simplicity, we omit the initialization stage of the first mode.

In the first mode, the above set of N frames includes the previous frame F(i−1). The decision module decides whether F(i−1) should be selected as the frame FR representing the content of a video segment SEG, terminated by F(i−1).

If so, the algorithm outputs the selected frame FR (which is F(i−1)), switches to the second mode and processes the current frame F(i). If not, the algorithm continues to work in the first mode and proceeds to the next frame F(i+1) which becomes a new current frame.

In the second mode the decision module already possesses the R-frame FR (which has been selected in the first mode of the algorithm) representing the video segment SEG terminated by the previous frame F(i−1). Therefore, in the second mode the decision module does not select the R-frame. Rather, it decides whether the FR adequately represents also the content of the current F(i).

If so, the algorithm updates SEG by adding F(i) and proceeds to the next current frame F(i+1) staying in the second mode. If not, the algorithm switches to the initialization stage of the first mode and process the current frame F(i).

The step-by-step description of a sample running of the algorithm is given below.

By such means, successive R-frames are selected, based on the content of the processed video frames. The selection itself requires an analysis of the content of the video frames. The analysis is not itself a feature of the present invention and numerous known techniques may be employed. Thus, as an alternative to the first preferred embodiment described above, the selection may use the clustering-based approach of Zhuang [3] or the local minima of the motion measure as described by Wolf [2].

In all these prior art approaches, it is generally necessary first for the computer to divide the sequence into segments. Most of the work that has been done on automatic video sequence segmentation has focused on identifying shots. A shot depicts continuous action in time and space. Methods for detecting shot transitions are described, for example, by Sethi et al., in “A Statistical Approach to Scene Change Detection” published in Proceedings of the Conference on Storage and Retrieval for Image and Video Databases III (SPIE Proceedings 2420, San Jose, Calif., 1995), pages 329-338, which is incorporated herein by reference. Further methods for finding shot transitions and identifying R-frames within a shot are described in U.S. Pat. Nos. 5,245,436, 5,606,655, 5,751,378, 5,767,923 and 5,778,108, which are also incorporated herein by reference.

When a shot is taken with a stationary camera and not too much action, a single R-frame will generally represent the shot adequately. When the camera is moving, however, there may be big differences in content between different frames in a single shot. Therefore, a better representation of the video sequence can be achieved by grouping frames into smaller segments that have similar content. An approach of this sort is adopted, for example, in U.S. Pat. No. 5,635,982, which is incorporated herein by reference. This patent describes an automatic video content parser, used to perform video segmentation and key frame (i.e., R-frame) extraction for video sequences having both sharp and gradual transitions. The system analyzes the temporal variation of video content and selects a key frame once the difference of content between the current frame and a preceding key frame exceeds a set of pre-selected thresholds. In other words, for each of the segments found by the system, the first frame in the segment is the R-frame, followed by a group of subsequent frames that are not too different from the R-frame.

The approach described by Zhuang et al. [3] divides each shot in a video sequence into one or more clusters of frames that are similar in visual content, but are not necessarily sequential. For example, the frames may be clustered according to characteristics of their color histograms, with frames from both the beginning and the end of a shot being grouped together in a single cluster. A centroid of the clustering characteristic is computed for each cluster, and the frame that is closest to the centroid is chosen to be the key frame for the cluster.

It is to be noted that in the preferred embodiment, only a relatively small number of frames is buffered. This renders the invention amenable for use also with streaming video since it can be carried out “on the fly” and does not require that a complete video sequence be stored or pre-processed as appears to be the case with Jun et al. [1]. This allows a smaller memory to be used for buffering the incoming video frames. The invention is nevertheless capable of application also in systems that buffer the whole of the video content prior to display.

It will also be noted that in the invention, the selected R-Frame is not necessarily (and most typically is not) the N^{th} frame, but rather is a frame selected from the preceding N frames that is considered best to represent the content of the video segment SEG. If no such frame is available, then the preceding R-Frame is displayed again, whereby the preceding R-Frame is effectively displayed for a longer time period than that dictated by the display speed. This avoids or at least reduces the flicker that would otherwise occur consequent to displaying every N^{th} frame for a constant time interval. Furthermore, since the refresh rate is not dependent on the complexity of the video content, there is no restriction on the time for which successive representative frames are displayed. It is therefore easy to ensure that the frames are displayed sufficiently long to avoid the unpleasant blinking of the images that can occur with hitherto-proposed approaches.

Moreover the N frames need not all precede the current frame, since all frames in an incoming stream of video frames may be buffered and processed sequentially for each successive frame in the buffer. In this case, only for the last frame in the buffer will the N frames be preceding frames. However, in a typical streaming environment, frames enter a limited buffer memory, are processed and exit from the buffer such that as soon as the earliest frames to arrive leave, new frames enter the buffer to replenish them. It is then simpler to process all frames remaining in the buffer in respect of the latest arrival, i.e. the current frame and then to release the earliest arrival and allow a new frame to enter.

FIG. 4 is a block diagram showing part of an R-Frame selector 35 for selecting R-Frames for display in a video streaming or buffered video system. The R-Frame selector 35 includes a buffer memory 36 for storing at least N preceding frames from an incoming video data stream. Coupled to the buffer memory 36 is a segment processor 37 that processes the N preceding frames so as to determine, based on their content, whether there exists among the N preceding frames a representative frame F_{R} that represents a content of the video segment SEG A representative frame processor 38 is coupled to the segment processor 37 for selecting a representative frame F_{R} for display. Thus, if the segment processor 37 determines that there exists among the N preceding frames a representative frame F_{R} that represents a content of a preceding displayed video segment, then it is accepted for display. If not, then the previous representative frame remains selected for display. The selected representative frame F_{R} is fed for display to a display driver 21 that may be part of the R-Frame selector 35 or may be external thereto.

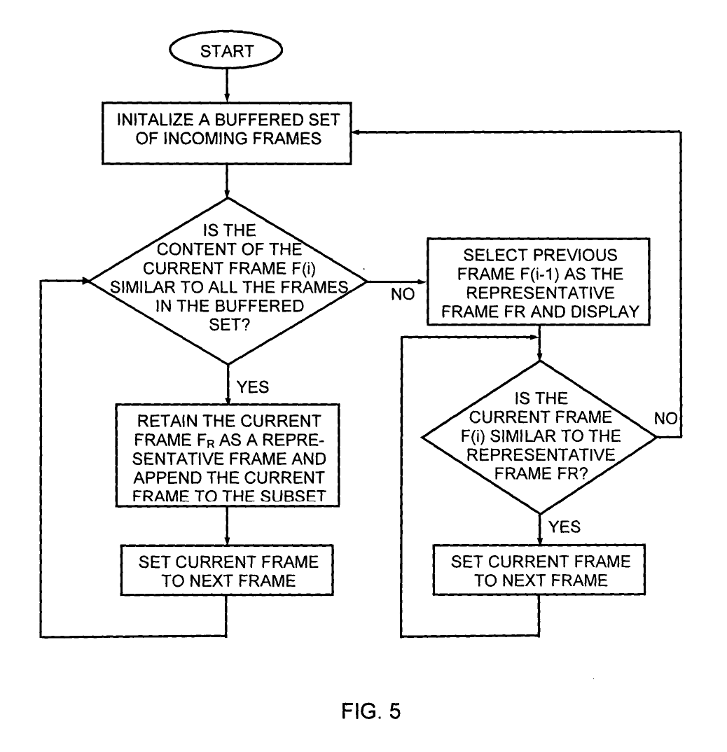

FIG. 5 is a flow diagram showing one possible implementation of the segment processor shown in FIG. 4 and corresponding to the algorithm described in “An algorithm for efficient segmentation and selection of representative frames in video sequences” [4, 5]. This algorithm will now be described operation-by-operation.

The rationale of this embodiment is as follows. Selection of the R-frame and the representative frame segment SEG consists of two stages. Each segment SEG consists of [“left half of SEG”+R-frame+“right half of SEG”]. There is first constructed the left half of the segment SEG terminated by R-frame. The R-frame is not yet selected while executing the first stage. The first stage is terminated by selection of the R frame. In the second stage the right half of SEG is constructed. The right half of SEG is started with the R-frame.

### Constructing the Left Half of SEG

The idea of constructing the left half is as follows. The goal is to select the R frame as far to the right as possible i.e. to extend the left half of the segment as far as possible. Consider, by way of example, that the start frame of a segment is denoted by F0, and that the start frame of the next segment is denoted by F17. The algorithm determines the first frame that significantly differs from all the preceding frames of the constructed segment. The previous frame is then the frame at maximal position which is similar to the preceding frames. This frame is selected as the R frame.

In order to estimate the above similarity between the current frame and all the preceding frames of the constructed segment, straightforward computation is not applicable, since the number of the preceding frames may be large. For this purpose a set S consisting of a small number of frames or their representations is used to construct the left half of the segment. Instead of comparing the current frame with all preceding frames of the constructed segment, it is compared with the frames from S only. The selection of S is not a feature of the invention and is described in [4, 5] “An algorithm for efficient segmentation and selection of representative frames in video sequences”.

### Constructing the Right Half of SEG

Construction of the right half of the segment is simple. Since the R frame is now known, the algorithm searches for the first frame which is not similar to the R frame. Then all the frames from R-frame to the previous frame compose the right half of the current segment.

In order not to complicate the description, the initialization steps will be omitted.

STEP #1:

Current frame: F7
The segment SEG which we want to represent by R frame:
   left end of SEG: F0
   right end of SEG: not yet defined
R-frame FR for SEG: not selected
Set S: frames F0, F2, F5
   Actions:
Estimate the similarity of the current frame F7 and each frame in S.
   Result:
F7 is similar to all the frames F0, F2, F5
   Actions:
Update S and proceed with the next frame F8
   STEP #2:
Current frame: F8
The segment SEG which we want to represent by R frame:
   left end of SEG: F0
   right end of SEG: not yet defined
R-frame FR for SEG: not selected
Set S: frames F0, F2, F7
   Actions:
Estimate the similarity of the current frame F8 and each frame in S.
   Result:
F8 is similar to all the frames F0, F2, F7
   Actions:
Update S and proceed with the next frame F9
   STEP #3:
Current frame: F9
The segment SEG which we want to represent by R frame:
   left end of SEG: F0
   right end of SEG: not yet defined
R-frame FR for SEG: not selected
Set S: frames F0, F2, F8
   Actions:
Estimate the similarity of the current frame F9 and each frame in S.
   Result:
F9 is similar to all the frames F0, F2, F8
   Actions:
Update S and proceed with the next frame F10. In fact, S is not changed after the update since F8 is more representative of the segment content than F9. So, F8 is retained and F9 is discarded.
   STEP #4:
Current frame: F10
The segment SEG which we want to represent by R frame:
   left end of SEG: F0
   right end of SEG: not yet defined
R-frame FR for SEG: not selected
Set S: frames F0, F2, F8
   Actions:
Estimate the similarity of the current frame F10 and each frame in S.
   Result:
F10 is similar to all the frames F0, F2, F8
   Actions:
Update S(S was not changed after the update) and proceed with the next frame F11.
   STEP #5:
Current frame: F11
The segment SEG which we want to represent by R frame:
   left end of SEG: F0
   right end of SEG: not yet defined
R-frame FR for SEG: not selected
Set S: frames F0, F2, F8
   Actions:
Estimate the similarity of the current frame F11 and each frame in S.
   Result:
F11 is similar to all the frames F0, F2, F8
   Actions:
Update the S and proceed with the next frame F12
   STEP #6:
Current frame: F12
The segment SEG which we want to represent by R frame:
   left end of SEG: F0
   right end of SEG: not yet defined
R-frame FR for SEG: not selected
Set S: frames F0, F2, F11
   Actions:
Estimate the similarity of the current frame F12 and each frame in S.
   Result:
F12 is similar to all the frames F0, F2, F11
   Actions:
Update S and proceed with the next frame F13
   STEP #7:
Current frame: F13
The segment SEG which we want to represent by R frame:
   left end of SEG: F0
   right end of SEG: not yet defined
R-frame FR for SEG: not selected
Set S: frames F0, F11, F12
   Actions:
Estimate the similarity of the current frame F13 with all frames in S.
   Result:
F13 is similar to all the frames F11, F12 but significantly differs from F0.
   Actions:
Select the previous frame F12 as R-frame for the segment SEG!
   STEP #8:
NOTE: Now, after the R frame has been selected, the algorithm proceeds in a different fashion in order to construct the right half of the represented segment.
Current frame: F13 (still)
The segment SEG which we want to represent by R frame:
   left end of SEG: F0
   right end of SEG: not yet defined
R-frame FR for SEG: F12
Set S: R-frame F12 only
   Actions:
Estimate the similarity of the current frame F13 with the R-frame
   Result:
F13 is similar to the R-frame F12
   Actions:
Proceed to the next current frame
   STEP #9:
Current frame: F14
The segment SEG which we want to represent by R frame:
   left end of SEG: F0
   right end of SEG: not yet defined
R-frame FR for SEG: F12
Set S: R-frame F12 only
   Actions:
Estimate the similarity of the current frame F14 with the R-frame
   Result:
F14 is similar to the R-frame F12
   Actions:
Proceed to the next current frame
   STEP #10:
Current frame: F15
The segment SEG which we want to represent by R frame:
   left end of SEG: F0
   right end of SEG: not yet defined
R-frame FR for SEG: F12
Set S: R-frame F12 only
   Actions:
Estimate the similarity of the current frame F15 with the R-frame
   Result:
F15 is similar to the R-frame F12
   Actions:
Proceed to the next current frame
   STEP #11:
Current frame: F16
The segment SEG which we want to represent by R frame:
   left end of SEG: F0
   right end of SEG: not yet defined
R-frame FR for SEG: F12
Set S: R-frame F12 only
   Actions:
Estimate the similarity of the current frame F16 with the R-frame
   Result:
F16 is similar to the R-frame F12
   Actions:
Proceed to the next current frame
   STEP #12:
Current frame: F17
The segment SEG which we want to represent by R frame:
   left end of SEG: F0
   right end of SEG: not yet defined
R-frame FR for SEG: F12
Set S: R-frame F12 only
   Actions:
Estimate the similarity of the current frame F17 with the R-frame
   Result:
F17 is not similar to the R-frame F12
   Actions:
Terminate the construction of SEG:
SEG consists of the frames F0 . . . F16
The whole procedure is now repeated in respect of subsequent segments and R-Frames.
   STEP #13:
Current frame: F18
The segment SEG which we want to represent by R frame:
   left end of SEG: F17
   right end of SEG: not yet defined
R-frame FR for SEG: not selected
Set S: frames F17
   Actions:
Estimate the similarity of the current frame F18 with all frames from S.
   Result:
F18 is similar to all the frames F17
   Actions:
Update S(S consists of the frames F17, F18) and proceed with the next frame F19 etc.

It will be understood that the above-described algorithm is but one example of an algorithm that is suitable for constructing segments and identifying one frame that is representative of the video content of that segment. One particular feature of the algorithm is that the representative frame is generally contained somewhere between the start and end of the segment and that the length of the segment is thereby maximized. Moreover, this is done without the need to buffer all frames of the segment, since frames that arrive constantly replace those that arrived earlier in the buffer.

It is also an advantage to maximize the length of the segment that can be represented by a single frame, since it permits the representative frame to be displayed for a longer period of time. This minimizes the blinking effect so often associated with hitherto-proposed systems. The actual time period for which each representative frame is displayed is selected to achieve the desired acceleration factor and preferably avoid blinking. Thus, in the specific example described in detail above, the first segment contains 17 frames being F0 . . . F16. If the required acceleration factor were 1 (i.e. no speed increase) then it would be necessary to display the representative frame for a period of time equal to 17 times the normal frame duration. If a 10× speed increase is required, this could be achieved by displaying the representative frame for a period of time equal to 1.7 times the normal frame duration.

The invention has been described with particular reference to a system that actually displays the representative frames. However, the invention may also find application in a sub-system that determines representative frames and then conveys them for display by an external module.

Likewise, the invention is applicable to any system where video is captured from an external source, and the decoding device cannot control it directly as is the case for TV broadcasting since the TV set-top box cannot “pause” the broadcasting side. Thus, while the invention has been described with particular regard to a TV set-top box, the principles of the invention are clearly equally applicable to other video systems and in particular Internet applications that meet this definition. In these cases, a computer may also emulate the functionality of the set-top box described above. Thus, it is to be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters and Roman numerals used to designate claim steps are provided for convenience only and do not imply any particular order of performing the steps.

1. A method for producing fast forward and backward preview of video, the method comprising:
processing incoming frames so as to derive successive representative frames whose content is representative of successive video segments, and
displaying said successive representative frames at a rate that achieves a desired acceleration factor.

2. The method according to claim 1, including displaying the representative frames for a period of time that is sufficiently long to avoid blinking.

3. The method according to claim 1, wherein a small number of incoming frames are buffered, and said method further comprises:
determining for the current frame in said small number of incoming frames whether there exists a frame F_{R} that represents the content of a segment surrounding the current frame,
if so, accepting the frame F_{R} as a representative frame for the said segment, displaying F_{R} as a new representative frame, and proceeding to the next incoming frame which becomes a new current frame;
if not, proceeding to the next incoming frame which becomes a new current frame and continuing the displaying the current representative frame, selected in an earlier iteration or during initialization.

4. The method according to claim 1, wherein a small number of incoming frames are buffered, and said method further comprises:
proceeding to the next incoming frame which becomes a new current frame and continuing the displaying the current representative frame, selected in an earlier iteration or during initialization.

5. The method according to claim 3, including:
receiving a sequence of video frames F(1), F(2), . . . , F(i), . . . ;
for a current frame F(i), storing a subset S of frames F(j(1)), F(j(2)), . . . , F(j(n)) preceding the current frame or a representation thereof;
determining whether the frame F(i) is similar to all the frames in said subset F(j(1)), F(j(2)), . . . , F(j(n));
if so, updating the set S of frames, appending the current frame F(i) to said current video segment, and proceeding to the next frame F(i+1) which becomes the new current frame;
if not, accepting a frame F(i−1) preceding the current frame F(i) as the representative frame F_{R} for said current video segment and appending successive frames F(i), F(i+1), F(i+2) . . . , to the current video segment until the content of one of said successive frames F(i+k) is no longer adequaltely represented by the representative frame FR; and
commencing a new video segment with said one of said successive frames F(i+k).

6. The method according to claim 5, wherein the frames in said subset F(j(1)), F(j(2)), . . . , F(j(n)) are sequential.

7. The method according to claim 5, wherein the frames in said subset F(j(1)), F(j(2)), . . . , F(j(n)) include frames that are non-sequential.

8. The method according to claim 4, including:
receiving a sequence of video frames F(1), F(2), . . . , F(i), . . . ;
for a current frame F(i), storing a subset S of frames F(j(1)), F(j(2)), . . . , F(j(n)) preceding the current frame or a representation thereof;
determining whether the frame F(i) is similar to all the frames in said subset F(j(1)), F(j(2)), . . . , F(j(n));
if so, updating the set S of frames, appending the current frame F(i) to said current video segment, and proceeding to the next frame F(i+1) which becomes the new current frame;
if not, accepting a frame F(i−1) preceding the current frame F(i) as the representative frame FR for said current video segment and appending successive frames F(i), F(i+1), F(i+2) . . . , to the current video segment until the content of one of said successive frames F(i+k) is no longer adequaltely represented by the representative frame F_{R}; and
commencing a new video segment with said one of said successive frames F(i+k).

9. The method according to claim 8, wherein the frames in said subset F(j(1)), F(j(2)), . . . , F(j(n)) are sequential.

10. The method according to claim 8, wherein the frames in said subset F(j(1)), F(j(2)), . . . , F(j(n)) include frames that are non-sequential.

11. An apparatus for selecting R-Frames for display in a video streaming or buffered video system, so as to produce fast forward and backward preview in an incoming sequence of video frames, said apparatus comprising:
a buffer memory for storing a small number of frames from an incoming video data stream,
a segment processor coupled to the buffer memory for comparing successive current frames with the small number of frames in the buffer memory and for appending each current frame to a current segment if a content of the current segment is represented by a content of the respective current frame and for otherwise commencing a new segment with the current frame, and
a representative frame processor coupled to the segment processor for determining for each segment a respective representative frame FR that represents a content of the segment.

12. The apparatus according to claim 11 further including:
a display driver coupled to the representative frame processor for displaying selected R-Frames.

13. A program storage device readable by machine, tangibly embodying a program of instructions executable by the machine to perform method steps for producing fast forward and backward preview of video, the method comprising:
processing incoming frames so as to derive successive representative frames whose content is representative of successive video segments, and
displaying said successive representative frames at a rate that achieves a desired acceleration factor.

14. A computer program product comprising a computer useable medium having computer readable program code embodied therein for producing fast forward and backward preview of video, the computer program product comprising:
computer readable program code for causing the computer to process incoming frames so as to derive successive representative frames whose content is representative of successive video segments, and
computer readable program code for causing the computer to display said successive representative frames at a rate that achieves a desired acceleration factor.

15. A program storage device readable by machine, tangibly embodying a program of instructions executable by the machine to perform method steps for producing fast forward and backward preview of video for which a small number of incoming frames are buffered, the method comprising:
determining whether each incoming frame may be associated with a current segment;
if so, appending the incoming frame to said segment, otherwise commencing a new segment with the incoming frame;
determining a respective representative frame for each segment; and
displaying the representative frames.

16. A computer program product comprising a computer useable medium having computer readable program code embodied therein for producing fast forward and backward preview of video for which a small number of incoming frames are buffered, the computer program product comprising:
computer readable program code for causing the computer to determine whether each incoming frame may be associated with a current segment;
computer readable program code for causing the computer to append the incoming frame to said segment if it may be associated with a current segment, and for otherwise commencing a new segment with the incoming frame;
computer readable program code for causing the computer to determine a respective representative frame for each segment; and
computer readable program code for causing the computer to display the representative frames.
